(19) United States
(12) Patent Application Publication
(10) Pub. No.: US 2016/0330670 A1
(43) Pub. Date: Nov. 10, 2016

(54) BASE STATION, COMMUNICATION METHOD, AND COMMUNICATION SYSTEM

(71) Applicant: FUJITSU LIMITED, Kawasaki-shi (JP)

(72) Inventors: Shunichi KONNO, Sendai (JP); Takayoshi ODE, Yokohama (JP); Akihiro YAMAMOTO, Kawasaki (JP)

(21) Appl. No.: 15/144,595

(22) Filed: May 2, 2016

(30) Foreign Application Priority Data
May 8, 2015 (JP) 2015-096106

(51) Int. Cl. H04W 36/30; H04W 74/08; H04W 36/08; H04W 72/04; H04W 72/08

(52) U.S. Cl. CPC H04W 36/30; H04W 72/0406; H04W 72/085; H04W 36/08; H04W 74/0833

(57) ABSTRACT

A base station being one of two base stations, the base station comprising: a processor configured to select a state of a terminal from a first state and a second state based on at least one of a communication type of data transmitted from one of the two base stations to the terminal and a transfer delay between the two base stations, the first state being a state in which a base station of the two base stations that transmits the data to the terminal is different from a base station of the two base stations that receives from the terminal a response signal corresponding to the data, the second state being a state in which a base station that transmits the data to the terminal is same as a base station that receives from the terminal the response signal corresponding to the data.

### CROSS-REFERENCE TO RELATED APPLICATION

This application is based upon and claims the benefit of priority of the prior Japanese Patent Application No. 2015-096106, filed on May 8, 2015, the entire contents of which are incorporated herein by reference.

### FIELD

The embodiments discussed herein are related to a base station, a communication method, and a communication system.

### BACKGROUND

Conventionally, there has been known a carrier aggregation (CA) that performs data transfer by using a plurality of component carriers (CCs) simultaneously in, for example, Long Term Evolution-Advanced (LTE-A) (refer to Japanese National Publication of International Patent Application No. 2014-513458, for example).

In the CA, for example, a primary component carrier (PCC) of a terminal is set in a macro base station having a wide communication range, and a secondary component carrier (SCC) of the terminal is set in a small base station having a narrow communication range, in some cases. In addition, such a cross carrier scheduling that the PCC transfers control information for data transfer by the SCC in the CA is known.

### SUMMARY

According to an aspect of the invention, a base station being one of two base stations, the base station includes a memory and, a processor coupled to the memory and configured to select a state of a terminal from a first state and a second state based on at least one of a communication type of data transmitted from one of the two base stations to the terminal and a transfer delay between the two base stations, the first state being a state in which a base station of the two base stations that transmits the data to the terminal is different from a base station of the two base stations that receives from the terminal a response signal corresponding to the data, the second state being a state in which a base station of the two base stations that transmits the data to the terminal is same as a base station of the two base stations that receives from the terminal the response signal corresponding to the data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary communication system according to an embodiment;

FIG. 2 is a diagram (1) illustrating an exemplary cell switching in the communication system according to the embodiment;

FIG. 3 is a diagram (2) illustrating an exemplary cell switching in the communication system according to the embodiment;

FIG. 4 illustrates an exemplary terminal and base stations according to the embodiment;

FIG. 5 illustrates an exemplary hardware configuration of a terminal according to the embodiment;

FIG. 6 illustrates an exemplary hardware configuration of a base station according to the embodiment;

FIG. 7 is a flowchart of exemplary processing by a small base station according to the embodiment;

FIG. 8 illustrates an exemplary state of the communication system according to the embodiment before a cell switching;

FIG. 9 illustrates an exemplary state after a cell switching when the small base station in the embodiment has a low communication quality;

FIG. 10 illustrates an exemplary state after a cell switching when the small base station has a high communication quality in the embodiment;

FIG. 11 illustrates an exemplary state after a cell switching when the small base station has a high communication quality in the embodiment;

FIG. 12 illustrates an exemplary QoS class applicable to the communication system according to the embodiment;

FIG. 13 illustrates an exemplary QCI applicable to the communication system according to the embodiment;

FIG. 14 illustrates an exemplary EPC network applicable to the communication system according to the embodiment;

FIG. 15 illustrates an exemplary TCP option applicable to the embodiment;

FIG. 16 is a sequence diagram illustrating an exemplary random access procedure applicable to the embodiment;

FIG. 17 is a sequence diagram illustrating an exemplary X2 handover applicable to the embodiment;

FIG. 18 is a sequence diagram illustrating an exemplary S1 handover applicable to the embodiment; and

FIG. 19 illustrates an exemplary control signal in the embodiment.

### DESCRIPTION OF EMBODIMENTS

In the above-described conventional technology, for example, such a communication path is available that the terminal transmits, to the macro base station, a response signal for data transmitted to the terminal by the small base station, and the macro base station forwards the response signal to the small base station. With such a communication path, it takes time to transfer the response signal depending on a transfer delay between the macro base station and the small base station, which leads to a large communication delay.

An aspect of the present disclosure provides a communication system, a base station device, and a terminal device, which may achieve a reduced communication delay.

Embodiments of a communication system, a base station device, and a terminal device according to the present disclosure are described below in detail with reference to the accompanying drawings.

### Embodiment

### Communication System According to Embodiment

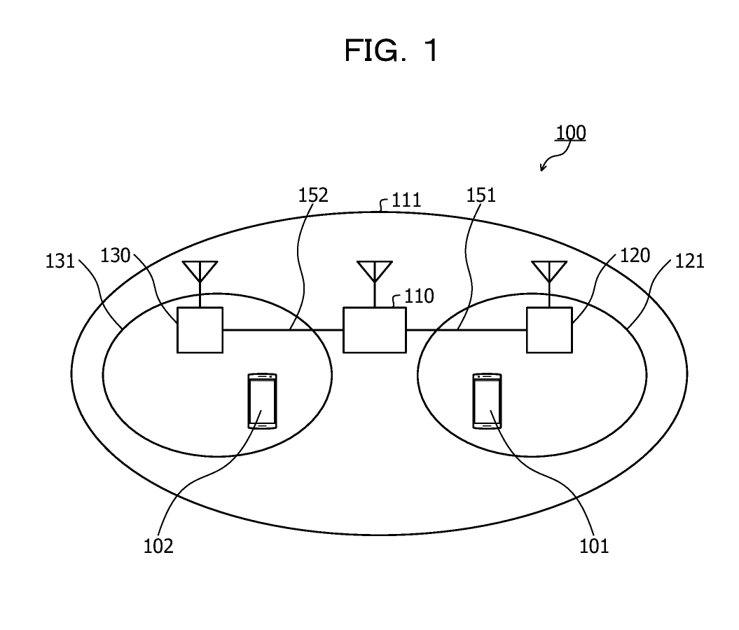

FIG. 1 illustrates an exemplary communication system according to an embodiment. As illustrated in FIG. 1, this communication system 100 according to the embodiment includes terminals 101 and 102, a macro base station 110, and small base stations 120 and 130. Examples of a communication scheme employed in the communication system 100 include various communication schemes such as Long Term Evolution (LTE) and LTE-A.

The macro base station 110 is a base station device that forms a macro cell 111 and performs wireless communication with a terminal present in the macro cell 111. The macro base station 110 is, for example, Evolved Node B (eNB) specified by the 3GPP. However, the macro base station 110 is not limited to the eNB, and may be various kinds of base stations.

The small base station 120 is a base station device that forms a small cell 121 and performs wireless communication with a terminal present in the small cell 121. The small base station 130 is a base station device that forms a small cell 131 and performs wireless communication with a terminal present in the small cell 131. The small cells 121 and 131 have cell ranges smaller than that of, for example, the macro cell 111. The cell ranges of the small cells 121 and 131 are, for example, included in that of the macro cell 111. The small cells 121 and 131 may be, for example, various small cells such as a femtocell, a picocell, and a nanocell.

The macro base station 110 is connected with the small base station 120 through, for example, an X2 interface 151. The macro base station 110 is connected with the small base station 130 through, for example, an X2 interface 152. The X2 interfaces 151 and 152 are, for example, physical or logical inter-base station interfaces. The X2 interfaces 151 and 152 are specified by, for example, TS36.420 of the 3GPP.

However, these inter-base station interfaces are not limited to X2 interfaces, and may be, for example, interfaces for a local area network (LAN), a Common Public Radio Interface (CPRI), and a wireless connection (relay). When the CPRI is used, the configuration corresponding to the small base stations 120 and 130 is called an optical feeder or a remote radio header (RRH).

The terminals 101 and 102 are each a terminal device present in the macro cell 111 of the macro base station 110 and capable of performing wireless communication with the macro base station 110. The terminal device is also referred to as, for example, a mobile device, a mobile communication device, or a user. The terminals 101 and 102 are, for example, user equipment (UE) specified by the 3GPP. However, the terminals 101 and 102 are not limited to UE and may be various terminals.

The terminal 101 is present in the small cell 121 of the small base station 120 and capable of performing wireless communication with the small base station 120. The terminal 102 is present in the small cell 131 of the small base station 130 and capable of performing wireless communication with the small base station 130.

The communication system 100 employs, for example, CA that performs data transfer using a plurality of CCs simultaneously. This achieves an extended frequency bandwidth and an improved bit rate. The CCs are, for example, LTE bands (having bandwidths of 1.4 [MHz], 3 [MHz], 5 [MHz], 10 [MHz], and 20 [MHz]). In the CA, according to Release 10, which is a LTE specification, five CCs (five frequency bands) may be achieved at maximum, in other words, a frequency bandwidth of 100 [MHz] (20 [MHz]*5) may be achieved at maximum. In the CA, each CC serves for a plurality of terminals and enables simultaneous communication between the terminals and the base stations.

The communication system 100 employs, for example, Orthogonal Frequency Division Multiple Access (OFDMA) as a multiple access method for downstream transmission. The communication system 100 also employs, for example, Single Carrier-Frequency Division Multiple Access (SC-FDMA) as a multiple access method for upstream transmission. When CA is performed, the communication system 100 employs, for example, Discrete Fourier Transform Spread Orthogonal Frequency Division Multiplexing (DFT-S-OFDM) as a multiple access method for upstream transmission.

For example, the communication system 100 performs such CA that simultaneously uses two CCs in a downlink and uses one CC in an uplink. This may achieve reduced electric power consumption in transmission from the terminal 101. The terminal 101 only requests to include a transmission circuit (for example, high frequency component) for one CC in an uplink, thereby achieving reduction in the circuit size of the terminal 101.

CA is achieved by first setting a channel between a base station and a terminal in one frequency band (CC) and then adding another frequency band (CC) thereto. A frequency band in which the first channel connection is established is referred to as, for example, a primary cell (P cell), a first band, a main band, a first cell, or a main cell. Hereinafter, the frequency band in which the first channel connection is established is referred to as the P cell. A cell is a communication area provided by one base station using one frequency band, and the frequency band corresponds to one cell and one base station in some cases. In the following, the frequency band (CC), the cell, and the base station are synonymous with each other.

A frequency band (CC) added to the P cell is referred to as, for example, a secondary cell (S cell), a second band, an extension band, a second cell, or a subordinate cell. Hereinafter, the band added to the P cell is referred to as the S cell.

The S cell may be one of a plurality of S cells. According to the current LTE specification, a cell index of three bits is set to each terminal. The cell index 0 represents the P cell, and the cell indices 1 to 7 represent the S cells. The maximum number of S cells is thus currently seven. Discussions are being made for a cell index of four bits. The maximum number of S cells is 15 for a cell index of four bits.

The macro base station 110 and the small base stations 120 and 130 may each serve as a P cell or an S cell for each terminal. The following describes a case in which the macro base station 110 is set as the P cell of the terminal 101 and the small base station 120 is set as the S cell of the terminal 101. The P cell is set for the terminal 101 before the S cell at an initial connection, a reconnection, a resetting, or a handover of the terminal 101, for example.

For example, at an initial connection, a reconnection, a resetting, or a handover of the terminal 101, a random access procedure is performed between the terminal 101 and the macro base station 110. In the random access procedure, transmission timing of the terminal 101 is adjusted and a terminal identifier thereof is set by a network (the macro base station 110). The terminal identifier is, for example, Cell-Radio Network Temporary Identifier (C-RNTI) or Temporary-C-RNTI (T-C-RNTI).

Thereafter, one or a plurality of S cells are set for the P cell, and subsequently the terminal 101 measures the wireless channel quality of each S cell and notifies the macro base station 110 of a result of the measurement. The wireless channel quality is, for example, a reference signal received power (RSRP), a reference signal received quality (RSRQ), or a received signal strength indicator (RSSI). The macro base station 110 selects S cells of the terminal 101 based on the notified wireless channel quality and notifies the terminal 101 of the selected S cells.

The following describes a method of transmitting a response signal (arrival acknowledgement information) from the terminal 101 to data transmitted from the macro base station 110 and the small base station 120. The description is made on the transmission of the response signal when communication between the macro base station 110 and the terminal 101 is performed using one CC for downstream and one CC for upstream.

Hybrid automatic repeat request (HARQ) is used for downstream wireless shared channels such as Wideband-Code Division Multiple Access (W-CDMA), High Speed-Physical Downlink Shared Channel (HS-PDSCH), and PDSCH of LTE. HARQ achieves improved performance of decoding error correction encoded information and improved wireless transfer quality by transmitting different information at initial transmission and retransmission.

For example, the terminal 101 determines whether data received from the macro base station 110 (P cell) is accurately transferred based on a cyclic redundancy check (CRC) added to the data. Having determined, based on the CRC, that there is no error, in other words, the data has correctly arrived at a transfer destination, the terminal 101 transmits an ACK (positive response signal) to the macro base station 110 through the P cell. Having determined, based on the CRC, that there is an error, in other words, the data has not correctly arrived at the transfer destination, the terminal 101 transmits an NACK (negative response signal) to the macro base station 110 through the P cell.

Having received the ACK or the NACK, the macro base station 110 performs a retransmission control in the HARQ through processing by a medium access controller (MAC) as an L2. For example, having received the ACK, the macro base station 110 transmits new data to the terminal 101. Having received the NACK, the macro base station 110 retransmits data to the terminal 101.

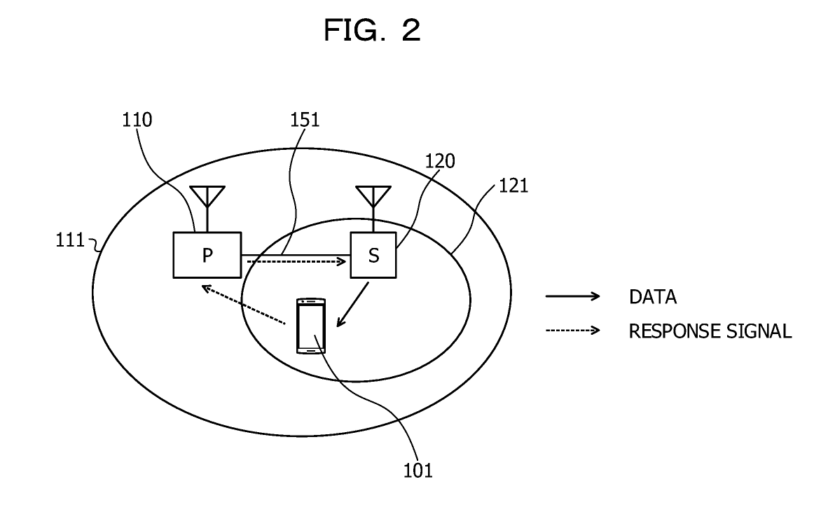

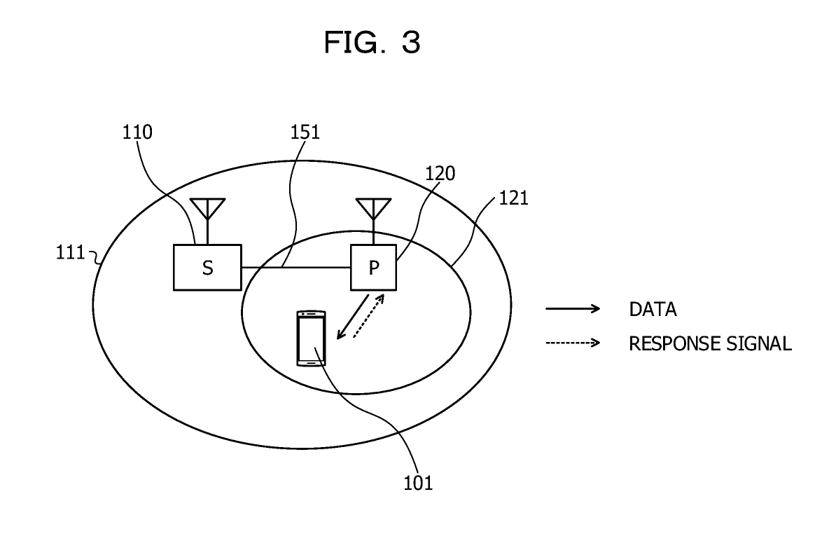

The following describes, with reference to FIGS. 2 and 3, transmission of a response signal when communication is performed between the terminal 101, and the macro base station 110 and the small base station 120, using two CCs for downstream and one CC for upstream. In such a case, cross carrier scheduling is performed that a downstream control channel is set only to the P cell and data is transferred in each CC using a control signal transferred through this control channel. The downstream control channel is, for example, Physical Downlink Control Channel (PDCCH), but is not limited thereto.

(Cell Switching in Communication System According to Embodiment)

FIGS. 2 and 3 each illustrate an exemplary cell switching in a communication system according to the embodiment. In FIGS. 2 and 3, the same part as that illustrated in FIG. 1 is denoted by an identical reference numeral and description thereof will be omitted. In the example illustrated in FIG. 2, the macro base station 110 is set as the P cell of the terminal 101, and the small base station 120 is set as the S cell of the terminal 101.

The terminal 101 receives downstream data from the small base station 120. The downstream data includes, for example, downstream user data and downstream control information. The terminal 101 transmits a response signal for the downstream data received from the small base station 120 to the macro base station 110 as the P cell. The macro base station 110 forwards the response signal received from the terminal 101 to the small base station 120 through the X2 interface 151.

When the small base station 120 is set as the S cell as described above, the response signal from the terminal 101 to the small base station 120 is transferred through the macro base station 110. Accordingly, while the macro base station 110 serves as the P cell of the terminal 101, data may be transferred from the small base station 120 to the terminal 101 and a response signal for the data may be transferred to the small base station 120. However, since the response signal is forwarded from the macro base station 110 to the small base station 120, the transfer of the response signal takes time and a communication delay becomes large depending on a transfer delay between the macro base station 110 and the small base station 120.

For example, when the macro base station 110 and the small base station 120 is connected through the X2 interface 151 (the Internet), the macro base station 110 converts the response signal from the terminal 101 into a protocol data unit (PDU) according to Transmission Control Protocol/Internet Protocol (TCP/IP) and forwards the converted response signal to the small base station 120.

The small base station 120 extracts the response signal from the PDU received from the macro base station 110 and performs the retransmission control by the MAC based on the extracted response signal. Thus, it takes time to, for example, convert the response signal into the PDU. Since the X2 interface 151 (the Internet) may not provide a shortest data transfer path, the transfer delay becomes large depending on the transfer path. The X2 interface 151 has a data transmission interval in the order of 10 [msec], for example. The LTE has a transmission interval of, for example, 2 [msec]. Since the X2 interface 151 has a transmission interval longer than that of the LTE, the use of the X2 interface 151 generates a transfer delay.

When the macro base station 110 and the small base station 120 are connected through an optical fiber by the CPRI, the macro base station 110 performs an electro-optic conversion (E/O conversion) of a response signal from the terminal 101 and forwards the converted response signal to the small base station 120 through the optical fiber. The small base station 120 performs an optoelectronic conversion (O/E conversion) of the response signal received from the macro base station 110 and performs a retransmission control by the MAC based on the O/E converted response signal. Thus, it takes time to perform the E/O conversion at the macro base station 110 and the O/E conversion at the small base station 120, for example.

When the macro base station 110 and the small base station 120 are wirelessly connected, the macro base station 110 performs error correction encoding and modulation on a response signal from the terminal 101 and forwards the resulting response signal to the small base station 120. The small base station 120 performs demodulation and error correction decoding on the response signal from the macro base station 110, and performs a retransmission control by the MAC based on the response signal obtained by the error correction decoding. Thus, it takes time to perform the above-described error correction encoding, modulation, demodulation, and error correction decoding, for example.

When the small base station 120 performs a retransmission control by a stop-and-wait method of the HARQ, a minimum value of timing of responding to a response signal for data transmission is specified. This minimum value is called a round-trip time (RTT), for example.

For a P cell for frequency division duplex (FDD), for example, the RU timer of the HARQ is set to eight subframes (8 [ms]). For a P cell for time division duplex (TDD), the RU timer of the HARQ is set to k+4 subframes (k+4 [ms]) (for example, refer to TS36.213 of the 3GPP).

In the example illustrated in FIG. 3, a switching between the P cell and the S cell of the terminal 101 is performed so that the small base station 120 is set as the P cell of the terminal 101 and the macro base station 110 is set as the S cell of the terminal 101.

The terminal 101 receives downstream data from the small base station 120. The terminal 101 transmits a response signal for the downstream data received from the small base station 120 to the small base station 120 as the P cell.

In this manner, when the small base station 120 is set as the P cell, the response signal from the terminal 101 to the small base station 120 is directly transferred to the small base station 120. This may reduce the transfer delay of the response signal from the terminal 101 to the small base station 120. However, it takes time to switch from the state (first state) in FIG. 2 to the state (second state) in FIG. 3. A delay may be allowed depending on the type of data transmitted to the terminal 101 in some cases.

In the communication system 100 according to the embodiment, whether to switch from the state in FIG. 2 to the state in FIG. 3 is determined based on the transfer delay between the macro base station 110 and the small base station 120 and the type of data. This determination is performed by at least one of the macro base station 110 and the small base station 120, for example. The following describes a case in which the small base station 120 performs this determination.

For example, when the transfer delay between the macro base station 110 and the small base station 120 is small, it may be determined that a condition is such that a response signal may be transferred within a time requested for a cell switching, in other words, a condition is such that the transfer delay of a response signal is smaller without the cell switching. In this case, the small base station 120 does not perform a switching from the state in FIG. 2 to the state in FIG. 3. This reduces a time requested for the cell switching, thereby achieving a reduced communication delay.

In contrast, when the transfer delay between the macro base station 110 and the small base station 120 is large, it may be determined that a condition is such that a response signal is not transferred within a time requested for a cell switching, in other words, a condition is such that the transfer delay of a response signal is smaller with the cell switching. In this case, the small base station 120 performs a switching from the state in FIG. 2 to the state in FIG. 3. This suppresses forwarding of a response signal from the macro base station 110 to the small base station 120, thereby achieving a reduced communication delay.

If data communication from the small base station 120 to the terminal 101 requests to be real time, it may be determined that a long RU is allowed. In this case, the small base station 120 does not perform a switching from the state in FIG. 2 to the state in FIG. 3. This reduces a time requested for the cell switching, thereby achieving a reduced communication delay.

In contrast, when data communication from the small base station 120 to the terminal 101 requests to be real time, it may be determined that a short RTT is requested. In this case, the small base station 120 executes a switching from the state in FIG. 2 to the state in FIG. 3. This suppresses forwarding of a response signal from the macro base station 110 to the small base station 120, thereby achieving a reduced communication delay.

The examples illustrated in FIGS. 2 and 3 describe the case in which the P cell and the S cell of the terminal 101 are switched, a base station different from the macro base station 110 and the small base station 120 may be set as at least one of the P cell and the S cell of the terminal 101.

(Terminal and Base Station According to Embodiment)

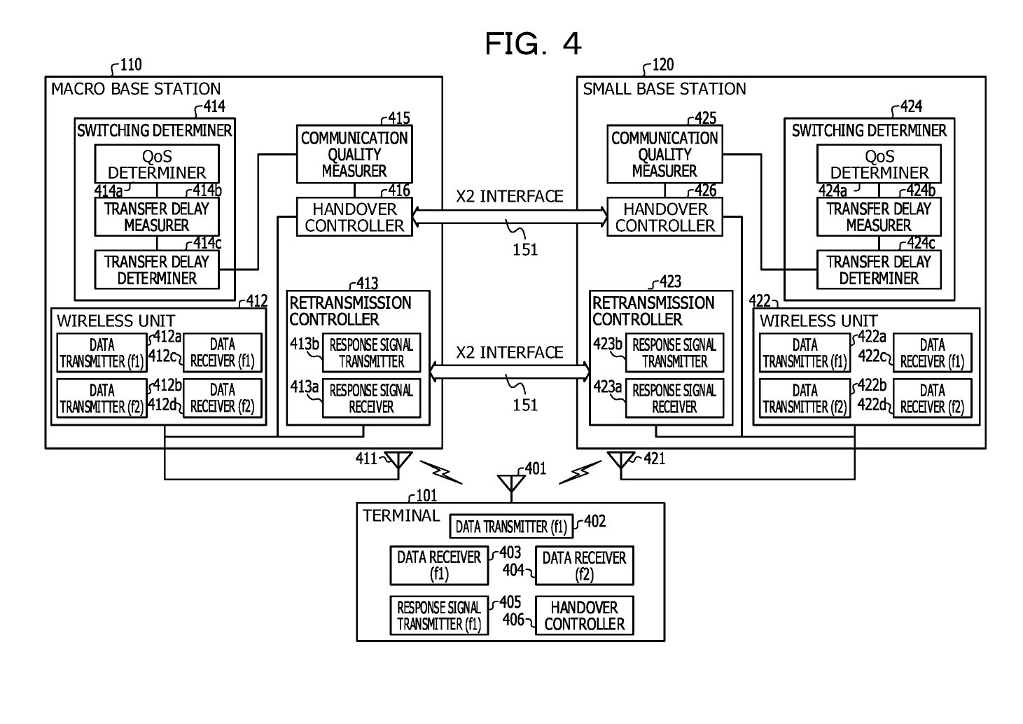

FIG. 4 illustrates exemplary terminals and base station according to the embodiment. In FIG. 4, although the configuration of the terminal 101 among the terminals 101 and 102 will be described, the terminal 102 has the same configuration as that of the terminal 101. In FIG. 4, although the configuration of the small base station 120 among the small base stations 120 and 130 will be described, the small base station 130 has the same configuration as that of the small base station 120. In FIG. 4, a first frequency band f1 corresponds to the P cell of the terminal 101, and a second frequency band f2 corresponds to the S cell of the terminal 101.

As illustrated in FIG. 4, the terminal 101 according to the embodiment includes an antenna 401, a data transmitter 402, a data receiver 403, a data receiver 404, a response signal transmitter 405, and a handover controller 406.

The data transmitter 402 transmits data through the antenna 401 to one of the macro base station 110 and the small base station 120, which is serving as the P cell of the terminal 101. The data transmitter 402 transmits the data in the first frequency band f1. For example, when the macro base station 110 serves as the P cell and the small base station 120 serves as the S cell, the data transmitter 402 transmits a response signal for user data received from the small base station 120 to the macro base station 110. When the macro base station 110 serves as the S cell and the small base station 120 serves as the P cell, the data transmitter 402 transmits a response signal for user data received from the small base station 120 to the small base station 120.

The data receiver 403 receives, through the antenna 401, data to be transmitted in the first frequency band f1 from one of the macro base station 110 and the small base station 120, which is serving as the P cell of the terminal 101. The data receiver 404 receives, through the antenna 401, data to be transmitted in the second frequency band f2 from one of the macro base station 110 and the small base station 120, which is serving as the S cell of the terminal 101.

The response signal transmitter 405 transmits, through the antenna 401, a response signal (ACK OR NACK) for the user data received by the data receiver 403 or the data receiver 404. The response signal transmitter 405 transmits the response signal for the user data received by any of the data receiver 403 and the data receiver 404, to one of the macro base station 110 and the small base station 120, which is serving as the P cell of the terminal 101. The response signal transmitter 405 transmits the response signal in the first frequency band f1.

The handover controller 406 performs, under control of the macro base station 110 and the small base station 120, a handover that switches base stations with which the terminal 101 is connected.

Since an uplink is set only for the P cell, the terminal 101 does not request to include a transmitter that transmits data in the second frequency band f2. Since the terminal 101 is not provided with the transmitter for the second frequency band f2, the configuration of the terminal 101 may be simplified.

As illustrated in FIG. 4, the macro base station 110 according to the embodiment includes an antenna 411, a wireless unit 412, a retransmission controller 413, a switching determiner 414, a communication quality measurer 415, and a handover controller 416.

The wireless unit 412 provides wireless communication at the macro base station 110. For example, the wireless unit 412 includes a data transmitter 412a, a data transmitter 412b, a data receiver 412c, and a data receiver 412d.

The data transmitter 412a transmits data in the first frequency band f1 to the terminal 101 through the antenna 411. For example, the data transmitter 412a transmits control information to the terminal 101. The data transmitter 412b transmits data in the second frequency band f2 to the terminal 101 through the antenna 411. For example, the data transmitter 412b transmits control information to the terminal 101.

The data receiver 412c receives, through the antenna 411, data transmitted in the first frequency band f1 from the terminal 101. For example, when the macro base station 110 serves as the P cell of the terminal 101, the data receiver 412c receives a response signal transmitted by the terminal 101 for data transmitted to the terminal 101 by the small base station 120. The data receiver 412d receives data in the second frequency band f2 through the antenna 411. However, in the example illustrated in FIG. 4, since the terminal 101 does not perform transmission in the second frequency band f2, the data receiver 412d may be omitted.

The retransmission controller 413 performs a control on retransmission of user data. For example, the retransmission controller 413 includes a response signal receiver 413a and a response signal transmitter 413b. The response signal receiver 413a receives, through the data receiver 412c, a response signal transmitted from the terminal 101. The response signal transmitter 413b transmits the response signal received by the response signal receiver 413a to the small base station 120 through the X2 interface 151.

The switching determiner 414 performs a determination on the cell switching of the terminal 101. The following describes a case in which the determination on the switching of the P cell and the S cell is performed for the macro base station 110 serving as the P cell of the terminal 101 and the small base station 120 serving as the S cell of the terminal 101. For example, the switching determiner 414 includes a QoS determiner 414a, a transfer delay measurer 414b, and a transfer delay determiner 414c.

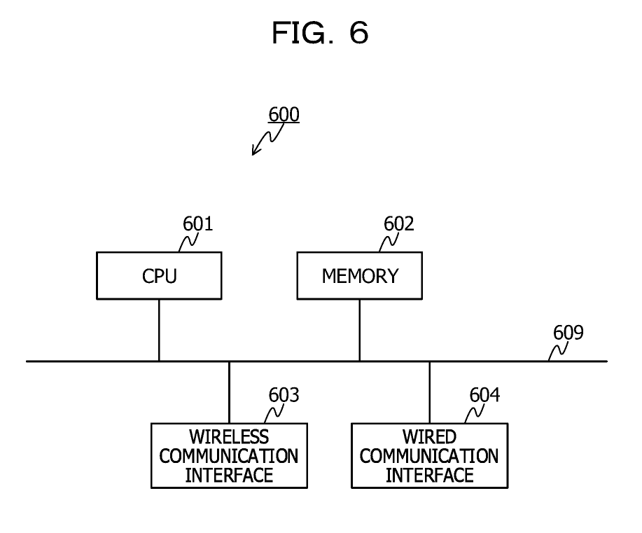

The QoS determiner 414a determines, for example, when a service of the terminal 101 is added, whether the QoS (quality of service) of the added service is categorized into real time (RT). The QoS of the added service is stored in a memory (for example, a memory 602 illustrated in FIG. 6) of the small base station 120, for example, when a bearer corresponding to the service is set. The QoS determiner 414a notifies the transfer delay measurer 414b of a result of the determination.

If the QoS determiner 414a determines that the QoS is not categorized into real time, the transfer delay measurer 414b measures a transfer delay from the P cell to the S cell before a cell switching. The transfer delay from the P cell to the S cell before a cell switching is, for example, a transfer delay between the macro base station 110 and the small base station 120 in transfer of a signal from the macro base station 110 to the small base station 120.

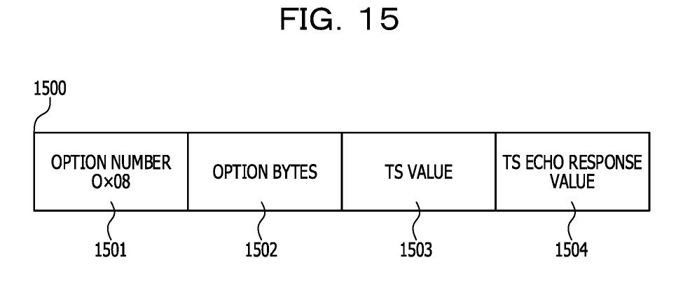

For example, the transfer delay measurer 414b calculates a difference between the transmission time of a packet received from the small base station 120, which is indicated by time stamp information included in the packet, and the reception time of the packet at the macro base station 110. In this manner, the transfer delay between the macro base station 110 and the small base station 120 may be measured. The packet used in the measurement may be various kinds of packets transmitted from the small base station 120 to the macro base station 110. An example of the time stamp information will be described later (refer to FIG. 15, for example).

When the transfer delay from the P cell to the S cell before a cell switching is fixed and stored in a memory (for example, the memory 602 illustrated in FIG. 6) of a base station, the transfer delay measurer 414b may read out the fixed transfer delay from the memory. The transfer delay measurer 414b notifies the transfer delay determiner 414c of the transfer delay thus measured or read out.

The transfer delay determiner 414c determines whether the transfer delay notified by the transfer delay measurer 414b is larger than a threshold. Then, the transfer delay determiner 414c notifies the communication quality measurer 415 of a result of the determination.

If the transfer delay determiner 414c determines that the transfer delay is larger than the threshold, the communication quality measurer 415 measures the communication quality (namely, wireless quality) of a downlink from the small base station 120 to the terminal 101. For example, the communication quality measurer 415 measures quality information such as the RSRP, the RSRQ, and the RSSI based on a report signal from the terminal 101. Then, the communication quality measurer 415 determines whether the measured communication quality is higher than a threshold. The communication quality measurer 415 notifies the handover controller 416 of a result of the determination.

If the communication quality measurer 415 determines that the communication quality is not higher the threshold, the handover controller 416 performs a control to execute the random access procedure between the terminal 101 and the small base station 120. Then, the handover controller 416 performs a control to cause the small base station 120 to set an uplink for the terminal 101. If the communication quality measurer 415 determines that the communication quality is higher than the threshold, the handover controller 416 performs a control to execute a handover of the terminal 101 to the small base station 120. These controls by the handover controller 416 are performed by performing communication with the small base station 120 through the X2 interface 151, for example.

As illustrated in FIG. 4, the small base station 120 according to the embodiment includes an antenna 421, a wireless unit 422, a retransmission controller 423, a switching determiner 424, a communication quality measurer 425, and a handover controller 426.

The wireless unit 422 provides wireless communication at the small base station 120. For example, the wireless unit 422 includes a data transmitter 422a, a data transmitter 422b, a data receiver 422c, and a data receiver 422d.

The data transmitter 422a transmits data in the first frequency band f1 to the terminal 101 through the antenna 421. For example, the data transmitter 422a transmits control information and user data to the terminal 101. The data transmitter 422b transmits data in the second frequency band f2 to the terminal 101 through the antenna 421. For example, the data transmitter 422b transmits control information to the terminal 101.

The data receiver 422c receives, through the antenna 421, data transmitted in the first frequency band f1 from the terminal 101. For example, when the small base station 120 serves as the P cell, the data receiver 422c receives a response signal transmitted by the terminal 101 for data transmitted to the terminal 101 by the data transmitter 422a. The data receiver 422d receives data in the second frequency band f2 through the antenna 421. However, in the example illustrated in FIG. 4, since the terminal 101 does not perform transmission in the second frequency band f2, the data receiver 422d may be omitted.

The retransmission controller 423 performs a control on retransmission of user data. For example, the retransmission controller 423 includes a response signal receiver 423a and a response signal transmitter 423b. The response signal receiver 423a receives, through the data receiver 422c, a response signal transmitted from the terminal 101. The response signal transmitter 423b transmits the response signal received by the response signal receiver 423a to the macro base station 110 through the X2 interface 151.

The switching determiner 424 performs a determination on the cell switching of the terminal 101. For example, the switching determiner 424 includes a QoS determiner 424a, a transfer delay measurer 424b, and a transfer delay determiner 424c. The QoS determiner 424a, the transfer delay measurer 424b, and the transfer delay determiner 424c are equivalent to the QoS determiner 414a, the transfer delay measurer 414b, and the transfer delay determiner 414c of the macro base station 110, respectively.

However, for example, the transfer delay measurer 424b calculates a difference between the transmission time of a packet received from the macro base station 110, which is indicated by time stamp information included in the packet, and the reception time of the packet at the small base station 120. In this manner, the transfer delay between the macro base station 110 and the small base station 120 may be measured. The packet used in the measurement may be various kinds of packets transmitted from the macro base station 110 to the small base station 120.

The communication quality measurer 425 and the handover controller 426 are equivalent to the communication quality measurer 415 and the handover controller 416 of the macro base station 110, respectively.

In the terminal 101, a receiver that receives data transmitted by the small base station 120 may be achieved by the data receiver 404, for example. In the terminal 101, a transmitter that transmits a response signal for data received by the receiver to the macro base station 110 may be achieve by the response signal transmitter 405, for example. In the terminal 101, a controller that performs a control of a cell switching may be achieved by the handover controller 406, for example.

In the macro base station 110, a receiver that receives a response signal transmitted by the terminal 101 may be achieved by the antenna 411, the data receiver 412c, and the response signal receiver 413a. In the macro base station 110, a forwarder that forwards the response signal received by the receiver to the small base station 120 may be achieved by the response signal transmitter 413b. In the macro base station 110, a controller that performs a control of a cell switching may be achieved by the switching determiner 414, the communication quality measurer 415, and the handover controller 416, for example.

In the small base station 120, a transmitter that transmits data to the terminal 101 may be achieved by the data transmitter 422b, for example. In the small base station 120, a receiver that receives, from the macro base station 110, a response signal transmitted to the macro base station 110 by the terminal 101 for the data transmitted by the transmitter may be achieved by the response signal receiver 423a, for example. In the small base station 120, a controller that performs a control of a cell switching may be achieved by the switching determiner 424, the communication quality measurer 425, and the handover controller 426, for example.

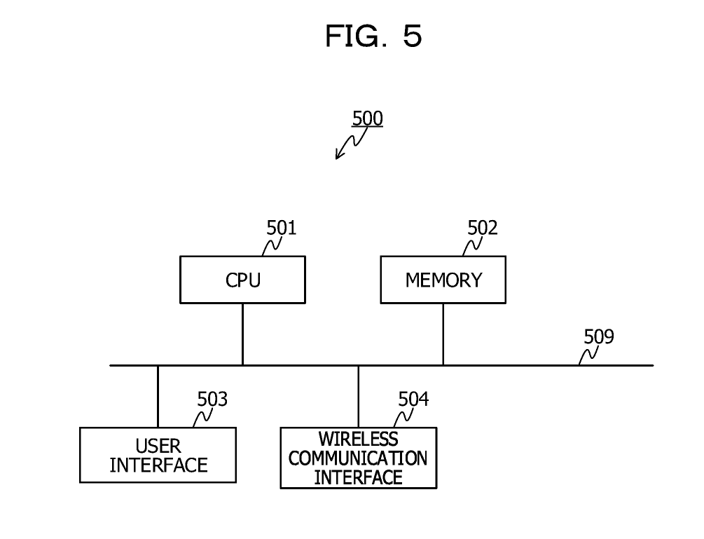

FIG. 5 illustrates an exemplary hardware configuration of a terminal according to the embodiment. The terminal 101 illustrated in FIG. 4 may be achieved by a communication device 500 illustrated in FIG. 5, for example. The communication device 500 includes a central processing unit (CPU) 501, a memory 502, a user interface 503, and a wireless communication interface 504. The CPU 501, the memory 502, the user interface 503, and the wireless communication interface 504 are connected with each other through a bus 509.

The CPU 501 governs a control of the entire communication device 500. The memory 502 includes, for example, a main memory and an auxiliary memory. The main memory is, for example, a random access memory (RAM). The main memory is used as a work area of the CPU 501. The auxiliary memory is, for example, a non-transitory memory such as a magnetic disk or a flash memory. The auxiliary memory stores various computer programs for operating the communication device 500. The programs stored in the auxiliary memory are loaded onto the main memory and executed by the CPU 501.

The user interface 503 includes, for example, an input device that receives an operation input from a user, and an output device that outputs information to the user. The input device may be achieved by a key (for example, a keyboard) or a remote controller, for example. The output device may be achieved by a display or a speaker, for example. The input device and the output device may be achieved by a touch panel, for example. The user interface 503 is controlled by the CPU 501.

The wireless communication interface 504 performs wireless communication with an outside (for example, the macro base station 110 and the small base stations 120 and 130) of the communication device 500. The wireless communication interface 504 is controlled by the CPU 501.

The antenna 401, the data transmitter 402, the data receiver 403, and the data receiver 404 illustrated in FIG. 4 may be achieved by the wireless communication interface 504, for example. The handover controller 406 illustrated in FIG. 4 may be achieved by the CPU 501, for example.

FIG. 6 illustrates an exemplary hardware configuration of a base station according to the embodiment. The macro base station 110 and the small base station 120 illustrated in FIG. 4 may be each achieved by a communication device 600 illustrated in FIG. 6, for example. The communication device 600 includes a CPU 601, the memory 602, a wireless communication interface 603, and a wired communication interface 604. The CPU 601, the memory 602, the wireless communication interface 603, and the wired communication interface 604 are connected with each other through a bus 609.

The CPU 601 governs a control of the entire communication device 600. The memory 602 includes, for example, a main memory and an auxiliary memory. The main memory is, for example, a RAM. The main memory is used as a work area of the CPU 601. The auxiliary memory is, for example, a non-transitory memory such as a magnetic disk, an optical disk, or a flash memory. The auxiliary memory stores various computer programs for operating the communication device 600. The programs stored in the auxiliary memory are loaded onto the main memory and executed by the CPU 601.

The wireless communication interface 603 performs wireless communication with an outside (for example, the terminals 101 and 102) of the communication device 600. The wireless communication interface 603 is controlled by the CPU 601.

The wired communication interface 604 performs wired communication with an outside (for example, a S-GW 801 and a MME 802 to be described later) of the communication device 600. The wired communication interface 604 includes, for example, an inter-base station interface such as the X2 interface 151 described above. The wired communication interface 604 is controlled by the CPU 601.

The antenna 411 and the wireless unit 412 of the macro base station 110 illustrated in FIG. 4 may be achieved by the wireless communication interface 603, for example. The retransmission controller 413 and the handover controller 416 of the macro base station 110 illustrated in FIG. 4 may be achieved by the CPU 601 and the wired communication interface 604, for example. The switching determiner 414 and the communication quality measurer 415 of the macro base station 110 illustrated in FIG. 4 may be achieved by the CPU 601, for example.

The antenna 421 and the wireless unit 422 of the small base station 120 illustrated in FIG. 4 may be achieved by the wireless communication interface 603, for example. The retransmission controller 423 and the handover controller 426 of the small base station 120 illustrated in FIG. 4 may be achieved by the CPU 601 and the wired communication interface 604, for example. The switching determiner 424 and the communication quality measurer 425 of the small base station 120 illustrated in FIG. 4 may be achieved by the CPU 601, for example.

(Processing by Small Base Station According to Embodiment)

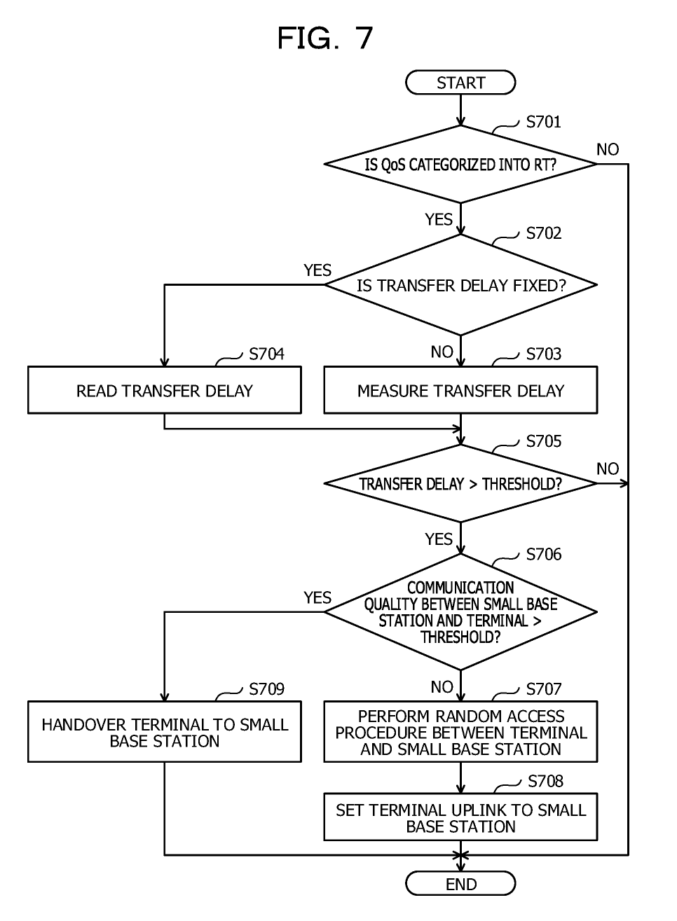

FIG. 7 is a flowchart of exemplary processing by a small base station according to the embodiment. The small base station 120 according to the embodiment executes steps illustrated in FIG. 7 at addition of a service, for example. The service is, for example, various services such as e-mail, chat, short message service (SMS), moving image distribution, and file transfer protocol (FTP). The addition of a service is, for example, setting of a bearer corresponding to the service.

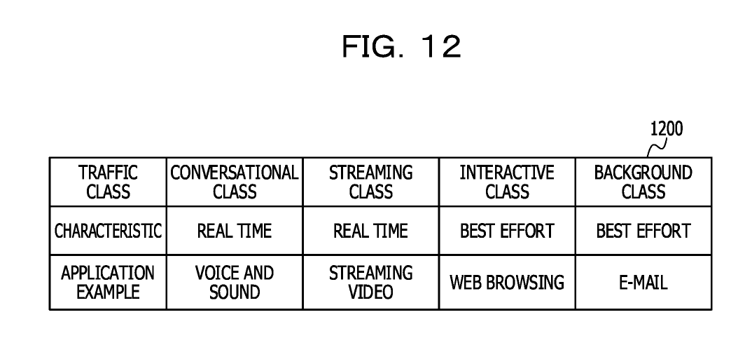

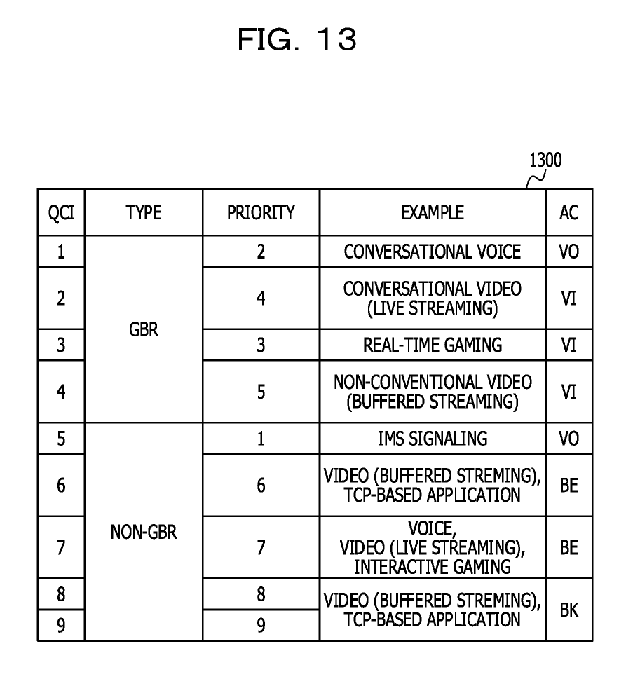

First, the small base station 120 determines whether the QoS of an added service is categorized into real time (RT) (step S701). Step S701 is executed by the QoS determiner 424a, for example. The determination at step S701 will be described later (refer to FIGS. 12 and 13, for example). Through the determination at step S701, the small base station 120 may determine based on the QoS whether to perform a cell switching to transferred data fast.

At step S701, if the QoS is not categorized into real time (No at step S701), it may be determined that a long RTT is allowed. In this case, the small base station 120 ends the process without a cell switching. This may reduce an increase in the amount of processing and the amount of signaling at each device due to the cell switching. Processing involved in the cell switching includes, for example, various kinds of processing such as measurement of a transfer delay, determination of the transfer delay, determination of a communication quality, and cell switching to be described later.

At step S701, if the QoS is categorized into real time (Yes at step S701), it may be determined that a short RTT is requested. In this case, the small base station 120 determines whether the transfer delay from the P cell to the S cell before a cell switching is fixed (step S702). Step S702 is executed by the transfer delay measurer 424b, for example. The transfer delay from the P cell to the S cell before a cell switching is, for example, a transfer delay between the macro base station 110 and the small base station 120 in transfer of a signal from the macro base station 110 to the small base station 120.

Whether the transfer delay from the P cell to the S cell is fixed is determined at, for example, installation of the small base station 120 depending on a method in which the macro base station 110 and the small base station 120 are connected with each other, and is stored in a memory of the small base station 120. If the transfer delay from the P cell to the S cell is fixed, the fixed transfer delay from the P cell to the S cell is stored in, for example, the memory of the small base station 120.

At step S702, if the transfer delay is not fixed (No at step S702), the small base station 120 measures the transfer delay from the P cell to the S cell before a cell switching (step S703), and proceeds to step S705. Step S703 is executed by the transfer delay measurer 424b, for example. A method of measuring the transfer delay at step S703 will be described later (refer to FIG. 15, for example).

At step S702, if the transfer delay is fixed (Yes at step S702), the small base station 120 reads the fixed transfer delay from the P cell to the S cell from the memory of the small base station 120 (step S704). Step S704 is executed by the transfer delay measurer 424b, for example.

Subsequently, the small base station 120 determines whether the transfer delay from the P cell to the S cell is larger than a threshold (step S705). Step S705 is executed by the transfer delay determiner 424c, for example. The transfer delay as the target of the determination at step S705 is the transfer delay measured at step S703 if the process proceeds from step S703 to step S705. Alternatively, the transfer delay as the target of the determination at step S705 is the transfer delay read out at step S704 if the process proceeds from step S704 to step S705.

The threshold for the target of the determination at step S705 may be set based on, for example, a time requested for a cell switching. For example, the threshold for the target of the determination at step S705 may be the sum of the time requested for a cell switching and a predetermined margin.

For example, when it is assumed that a delay time of a response signal in a wireless zone is not changed, a shortened amount of the RU of a response signal by a cell switching is equal to a transfer duration of the response signal from the macro base station 110 to the small base station 120. Thus, through the determination at step S705, the small base station 120 may determine whether the bit rate is higher when a cell switching is performed or when a cell switching is not performed.

At step S705, if the transfer delay is not larger than the threshold (No at step S705), it may be determined that a condition is such that a response signal may be transferred within a time requested for a cell switching, in other words, a condition is such that the transfer delay of a response signal is smaller without a cell switching. In this case, the small base station 120 ends the process without a cell switching.

At step S705, if the transfer delay is larger than the threshold (Yes at step S705), it may be determined that a condition is such that a response signal is not transferred within a time requested for a cell switching, in other words, a condition is such that the transfer delay of a response signal is smaller with a cell switching. In this case, the small base station 120 determines whether the communication quality between the small base station 120 and the terminal 101 is higher than a threshold (step S706). Step S706 is executed by the communication quality measurer 425, for example. The communication quality measured at step S706 is, for example, the communication quality of a downlink from the small base station 120 to the terminal 101.

At step S706, if the communication quality is not higher than the threshold (No at step S706), the speed of transfer of data from the small base station 120 to the terminal 101 is low. Thus, it may be determined that an improved throughput is not achieved by switching a path through which data from the network is forwarded from the macro base station 110 to the small base station 120 to a path through which the data from the network is directly received by the small base station 120.

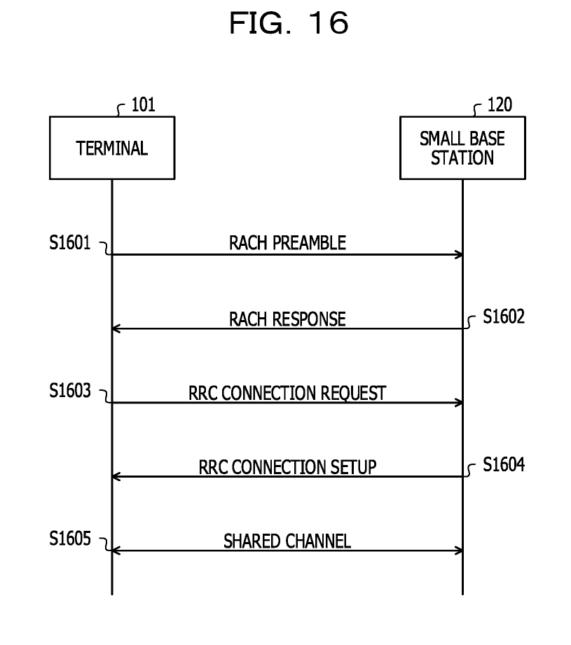

In this case, the small base station 120 executes the random access procedure between the terminal 101 and the small base station 120 (step S707). Step S707 is executed by the handover controller 426, for example. The random access procedure at step S707 will be described later (refer to FIG. 16, for example).

Subsequently, the small base station 120 sets an uplink for the terminal 101 to the small base station 120 (step S708), and ends the process. Step S708 is executed by the handover controller 426, for example. Through step S708, the P cell of the terminal 101 is switched to be the small base station 120.

At step S706, if the communication quality is higher than the threshold (Yes at step S706), the speed of transfer of user data from the small base station 120 to the terminal 101 is fast. In this case, forwarding of individual data from the macro base station 110 to the small base station 120 would cause a delay of forwarding of individual data from the small base station 120 to the terminal 101 from transfer of individual data from the small base station 120 to the terminal 101, and thus would generate a wait time. For this reason, it may be determined that an improved throughput is achieved by switching from a path through which user data from the network is forwarded from the macro base station 110 to the small base station 120 to a path through which the user data from the network is directly received by the small base station 120.

In this case, the small base station 120 performs a handover of the terminal 101 to the small base station 120 (step S709), and ends the process. Step S709 is executed by the handover controller 426, for example. At step S709, the small base station 120 performs, for example, a control to delete the S cell of the terminal 101, and then a control to hand over the terminal 101 to the small base station 120, so as to set the small base station 120 as the P cell of the terminal 101. Then, the small base station 120 performs a control to add the S cell of the terminal 101. The S cell thus added may be the macro base station 110 originally serving as the P cell, or another base station.

Through step S709, the P cell of the terminal 101 is switched to be the small base station 120. This involves a switch to a path through which user data from the network is received by the small base station 120 in place of the macro base station 110, and the small base station 120 transmits the user data received from the network to the terminal 101.

The above describes the case of determining at step S705 whether the fixed transfer delay is larger than the threshold when the transfer delay from the P cell to the S cell is fixed, but the present embodiment is not limited to such processing. For example, the memory of the small base station 120 may store information indicating whether to perform a cell switching when the transfer delay from the P cell to the S cell is fixed. In this case, the small base station 120 reads out, from the memory, the information indicating whether to perform a cell switching when the transfer delay from the P cell to the S cell is fixed. Then, the small base station 120 proceeds to step S706 if the read information indicates that a cell switching is to be performed. The small base station 120 ends the process without a cell switching if the read information indicates that the cell switching is not to be performed.

The above describes the case in which a cell switching is not performed when the QoS of an added service is not real time, but the present embodiment is not limited to such processing. For example, when the ratio of real-time services among services of each terminal relayed by the small base station 120 is smaller than a threshold although the QoS of the added service is not real time, it may be determined that a load on the small base station 120 is small. Thus, the small base station 120 may proceed to step S702 if the ratio of real-time services among services of each terminal relayed by the small base station 120 is smaller than the threshold although the QoS of the added service is not real time.

For example, if a service (bearer) having served as a trigger of a cell switching through the steps illustrated in FIG. 7 is removed, the P cell of the terminal 101 may be switched back to the macro base station 110, and the S cell of the terminal 101 may be switched back to the small base station 120. This may facilitate a control of a cell switching. However, the present embodiment is not limited to such processing, and the P cell and the S cell of the terminal 101 may not be switched back even when the service having served as a trigger of a cell switching is removed. For example, when a load caused by switching back the P cell and the S cell of the terminal 101 is large or the communication is about to end (for example, an RRC idle state), the P cell and the S cell of the terminal 101 may not be switched back.

The above describes the case in which the steps illustrated in FIG. 7 are performed by the small base station 120 (the S cell), but the steps illustrated in FIG. 7 may be performed by the macro base station 110 (P cell). In this case, the macro base station 110 may acquire, from the small base station 120, the above-described transfer delay from the P cell to the S cell.

As described above, the determination on whether to switch the P cell of the terminal 101 to be the small base station 120 may be performed by the small base station 120 or the macro base station 110. A control to switch the P cell of the terminal 101 to be the small base station 120 may be performed by the small base station 120 and the macro base station 110 under control of one of the small base station 120 and the macro base station 110, which has performed the determination, for example.

The above describes the case in which whether to perform a cell switching is determined based on the QoS (communication type) and the transfer delay between base stations, but a determination based on any one of the QoS and the transfer delay between base stations may be omitted. For example, when the transfer delay between base stations is large, a cell switching may be performed irrespective of the QoS. When the QoS is categorized into real time, a cell switching may be performed irrespective of the transfer delay between base stations.

(State of Communication System According to Embodiment Before Cell Switching)

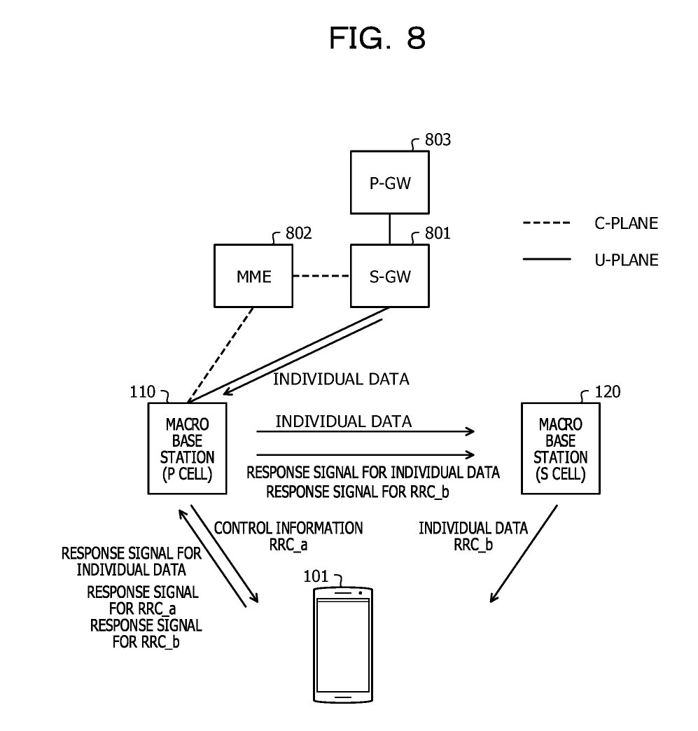

FIG. 8 illustrates an exemplary state of a communication system according to the embodiment before a cell switching. In FIG. 8, the same part as that illustrated in FIG. 1 is denoted by an identical reference numeral and description thereof will be omitted. The macro base station 110 and the small base station 120 are each connectable with, for example, the serving-gateway (S-GW) 801 and the Mobility Management Entity (MME) 802 illustrated in FIG. 8. The S-GW 801 is connected with a packet data network-gateway (P-GW) 803.

The S-GW 801 and the P-GW 803 are connected through, for example, a physical or logical interface. The interface between the S-GW 801 and the P-GW 803 is, for example, an S5 interface, but is not limited thereto.

The macro base station 110 and the small base station 120 are each connected with the MME 802 through, for example, a physical or logical interface. The interface between the MME 802 and each of the macro base station 110 and the small base station 120 is a control plane interface used in, for example, paging distribution to the terminal 101, setting of user data forwarding path, and non-access stratum (NAS) message transfer. The interface between the MME 802 and each of the macro base station 110 and the small base station 120 is, for example, an S1 interface (S1-MME), but is not limited thereto.

The macro base station 110 and the small base station 120 are each connected with the S-GW 801 by, for example, a physical or logical interface. The interface between the S-GW 801 and each of the macro base station 110 and the small base station 120 is a user plane interface used to transfer a user IP packet, for example. The interface between the S-GW 801 and each of the macro base station 110 and the small base station 120 is, for example, an S1 interface (S1-U), but is not limited thereto.

The MME 802 includes the macro base station 110 and the small base station 120, and performs processing of a control plane (C-plane) in communication through the macro base station 110 and the small base station 120. For example, the MME 802 performs processing of the C-plane in communication of the terminal 101 through the macro base station 110 or the small base station 120. The C-plane is, for example, a functional group for controlling a phone call between devices and the network. For example, the C-plane is used in connection of a packet call, setting of a path for transferring user data, and control of handover.

The P-GW 803 is a packet data network gateway for connection with an external network. The external network is, for example, the Internet, but is not limited thereto. The P-GW 803 replays user data between the S-GW 801 and the external network, for example.

In the example illustrated in FIG. 8, the macro base station 110 is set as the P cell of the terminal 101 and the small base station 120 is set as the S cell of the terminal 101. In this case, the S-GW 801 transmits individual data (dedicated data) for the terminal 101 to the macro base station 110 as the P cell. The individual data includes user data for the terminal 101.

The macro base station 110 transmits downstream control information to the terminal 101. The macro base station 110 also transmits a RRC_a as a downstream radio resource control (RRC) to the terminal 101. In addition, the macro base station 110 forwards, to the small base station 120, the individual data for the terminal 101 transmitted from the S-GW 801.

The small base station 120 transmits RRC_b as a downstream RRC to the terminal 101. The small base station 120 also transmits, to the terminal 101, the individual data forwarded from the macro base station 110.

The terminal 101 transmits, to the macro base station 110, a response signal for the RRC_a from the macro base station 110. The terminal 101 also transmits, to the macro base station 110, a response signal for the individual data received from the small base station 120 and a response signal for the RRC_b received from the small base station 120.

The macro base station 110 performs a retransmission control of the RRC_a for the terminal 101 based on the response signal for the RRC_a received from the terminal 101. The macro base station 110 forwards, to the small base station 120, the response signal for the individual data received from the terminal 101 and the response signal for the RRC_b received from the terminal 101. The small base station 120 performs a retransmission control of the individual data to be transmitted to the terminal 101 and the RRC_b based on the response signals forwarded from the macro base station 110.

The individual data is transmitted by the P cell and the S cell in the current CA, but it assumed in the future that the number of small cells increases, so that a macro cell is dedicated to a control of the small cells, and does not perform transfer of the individual data as in the present embodiment.

(State after Cell Switching when Small Base Station has Low Communication Quality in Embodiment)

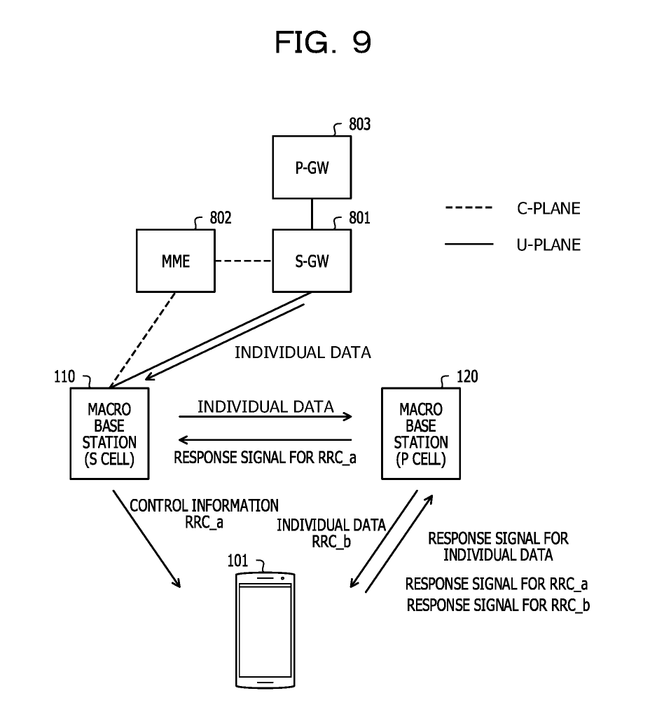

FIG. 9 illustrates an exemplary state after a cell switching when a small base station has a low communication quality in the embodiment. In FIG. 9, the same part as that illustrated in FIG. 8 is denoted by an identical reference numeral and description thereof will be omitted. For example, upon execution of steps S707 and S708 illustrated in FIG. 7, the state illustrated in FIG. 8 shifts to the state illustrated in FIG. 9.

In other words, the terminal 101 performs the random access procedure with the small base station 120 under control of the small base station 120 so as to establish connection with the small base station 120. Then, the terminal 101 switches a cell with which an uplink is performed to be the small base station 120 (small cell).

In this manner, the small base station 120 is set as the P cell of the terminal 101. It is assumed that the macro base station 110 is set as the S cell of the terminal 101. In the example illustrated in FIG. 9, a handover of the terminal 101 to the small base station 120 is not performed, and thus the S-GW 801 transmits individual data for the terminal 101 to the macro base station 110, similarly to the state illustrated in FIG. 8.

In the example illustrated in FIG. 9, the small base station 120 is set as the P cell of the terminal 101, and thus the terminal 101 transmits each uplink signal to the small base station 120. For example, the terminal 101 transmits a response signal for the RRC_a received from the macro base station 110, a response signal for individual data received from the small base station 120, and a response signal for the RRC_b received from the small base station 120, to the small base station 120.

The small base station 120 performs a retransmission control of the RRC_b and the individual data for the terminal 101 based on the response signal received from the terminal 101. The small base station 120 forwards, to the macro base station 110, the response signal for the RRC_a received from the terminal 101. The macro base station 110 performs a retransmission control of the RRC_a for the terminal 101 based on the response signal forwarded from the small base station 120.

(State after Cell Switching when Small Base Station has High Communication Quality in Embodiment)

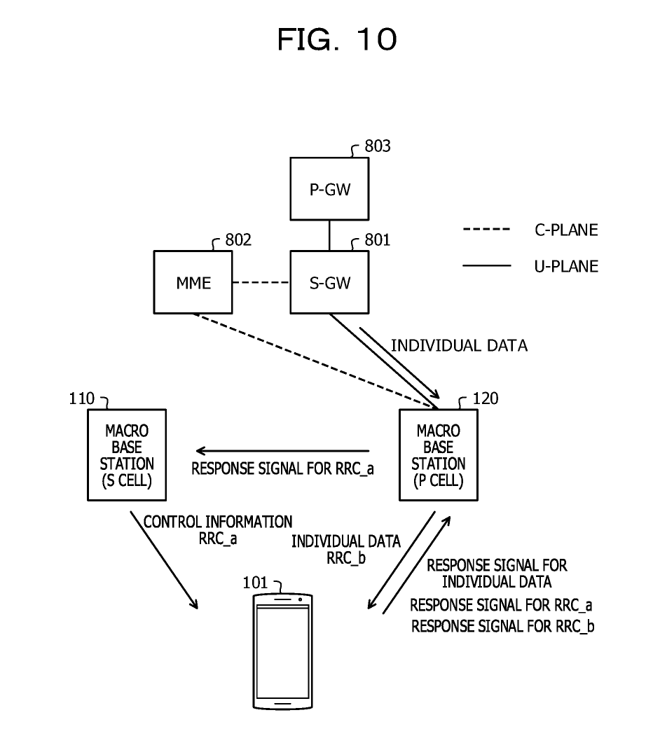

FIG. 10 illustrates an exemplary state after a cell switching when a small base station has a high communication quality in the embodiment. In FIG. 10, the same part as that illustrated in FIG. 8 or 9 is denoted by an identical reference numeral and description thereof will be omitted. For example, upon execution of step S709 illustrated in FIG. 7, the state illustrated in FIG. 8 shifts to the state illustrated in FIG. 10.

In other words, the terminal 101 performs a handover to the small base station 120 under control of the small base station 120. Accordingly, the small base station 120 is set as the P cell of the terminal 101. It is assumed that the macro base station 110 is set as the S cell of the terminal 101. In the example illustrated in FIG. 10, since the handover of the terminal 101 to the small base station 120 is performed, the S-GW 801 transmits individual data for the terminal 101 to the small base station 120.

In the example illustrated in FIG. 10, since the small base station 120 is set as the P cell of the terminal 101, the terminal 101 transmits each uplink signal to the small base station 120, similarly to the example illustrated in FIG. 9.

As illustrated in FIGS. 9 and 10, there exist two modes of connection between a base station and the MME or the S-GW depending on whether to switch the S1 interface when the P cell of the terminal 101 is switched to be the small base station 120. The first mode uses the S1 interface between the macro base station 110 and the S-GW 801, the MMEs 802 and the P-GW 803 as illustrated in FIG. 9. In this mode, the S1 interface is not switched and only an uplink is switched. The second mode uses the S1 interface between the small base station 120 and the S-GW 801, the MMEs 802 and the P-GW 803, as illustrated in FIG. 10.

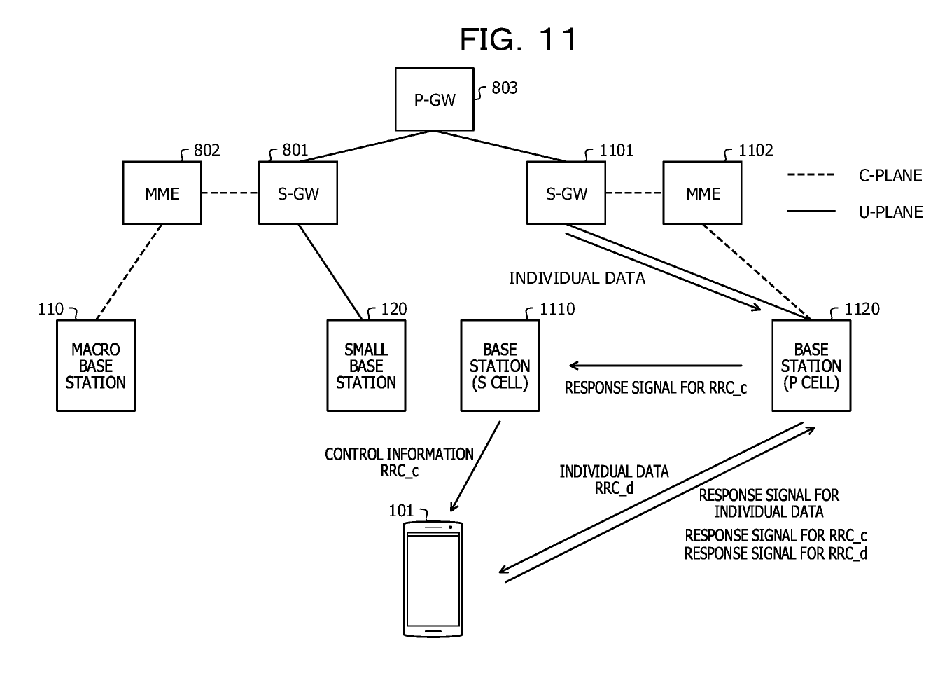

The above describes the examples illustrated in FIGS. 9 and 10 in which the P cell and the S cell of the terminal 101 in the state illustrated in FIG. 8 are switched therebetween through a cell switching, but the present embodiment is not limited to such a cell switching. For example, the P cell and the S cell of the terminal 101 may be each switched to be a base station different from the macro base station 110 and the small base station 120. The switching may be made to a base station connected with a S-GW and a MME different from the S-GW 801 and the MME 802. The following describes such an example with reference to FIG. 11.

FIG. 11 illustrates another exemplary state after a cell switching when the small base station has a high communication quality in the embodiment. In FIG. 11, the same part as that illustrated in FIG. 10 is denoted by an identical reference numeral and description thereof will be omitted. A S-GW 1101 illustrated in FIG. 11 is different from the S-GW 801 connected with the P-GW 803. The S-GW 1101 replays an U-plane between the P-GW 803 and base stations 1110 and 1120.

A MME 1102 includes the base stations 1110 and 1120 and performs processing of a C-plane in communication through the base stations 1110 and 1120. The base stations 1110 and 1120 are different from the macro base station 110 and the small base station 120. The base stations 1110 and 1120 may be each a small cell or a macro cell.

For example, upon execution of step S709 illustrated in FIG. 7, the state illustrated in FIG. 8 may shift to the state illustrated in FIG. 11. In other words, the small base station 120 may switch the P cell of the terminal 101 to be base station 1120 and switch the S cell of the terminal 101 to be the base station 1110. In the example illustrated in FIG. 11, a handover of the terminal 101 to the small base station 120 is performed, and thus the P-GW 803 transmits individual data for the terminal 101 to the S-GW 1101. The S-GW 1101 transmits the individual data for the terminal 101 transmitted from the P-GW 803 to the base station 1120.

The base station 1110 transmits downstream control information to the terminal 101. The base station 1110 also transmits a RRC_c as a downstream RRC to the terminal 101. The base station 1120 transmits individual data for the terminal 101 received from the S-GW 1101 to the terminal 101. The base station 1120 also transmits a RRC_d as a downstream RRC to the terminal 101.

In the example illustrated in FIG. 11, the base station 1120 is set as the P cell of the terminal 101, and thus the terminal 101 transmits each uplink signal to the base station 1120. For example, the terminal 101 transmits a response signal for individual data received from the base station 1120, a response signal for the RRC_c received from the base station 1110, and a response signal for the RRC_d received from the base station 1120, to the base station 1120.

The base station 1120 forwards the response signal for the RRC_c received from the terminal 101 to the base station 1110. The base station 1120 performs a retransmission control of individual data for the terminal 101 based on the response signal for individual data received from the terminal 101. The base station 1120 also performs a retransmission control of the RRC_d for the terminal 101 based on the response signal for the RRC_d received from the terminal 101. The base station 1110 performs a retransmission control of the RRC_c for the terminal 101 based on the response signal for the RRC_c forwarded from the base station 1120.

(QoS Class Applicable to Communication System According to Embodiment)

FIG. 12 illustrates an exemplary QoS class applicable to a communication system according to the embodiment. The QoS is a technology that reserves a band for a particular communication to guarantee a uniform communication speed. The data bit rate is specified based on, for example, a maximum transfer delay specified as a property of the QoS.

A QoS class 1200 illustrated in FIG. 12 is an exemplary Universal Mobile Telecommunications System (UMTS) QoS class specified by TS23.107 of the 3GPP. The QoS class 1200 illustrated in FIG. 12 lists a basic characteristic and an application example for each traffic class. As listed in the QoS class 1200, the QoS is categorized into a conversational class, a streaming class, an interactive class, and a background class.

Each QoS class is categorized into real time (RT) and best effort. The best effort is also called non-real time (NRT). A real time QoS class is applied to services such as voice and sound and streaming, which request to be real time. A best effort QoS class is applied to services such as web browsing and e-mail, which are less affected by a communication delay.

For example, at step S701 illustrated in FIG. 7, the small base station 120 may determine that the QoS is categorized into real time when the QoS class of an added service is the conversational class or the streaming class. The small base station 120 may also determine that the QoS is not categorized into real time when the QoS class of an added service is the interactive class or the background class.

The QoS has attributes such as a maximum bit rate, a guaranteed bit rate, a maximum SDU size, a SDU format information, a SDU error ratio, a residual bit error ratio, a transfer delay, and a traffic handling priority (refer to TS23.107 of the 3GPP, for example).

FIG. 13 illustrates an exemplary QoS class identifier (QCI) applicable to a communication system according to the embodiment. A table 1300 illustrated in FIG. 13 is an exemplary QCI specified by TS23.203 of the 3GPP. The QoS class is notified as, for example, the QCI in the table 1300. The QCI is, for example, the QoS class of a bearer in the Evolved Packet Core (EPC) of LTE. The QCI has a value of 1 to 9, and a band guarantee and a small delay are requested when the value is smaller.

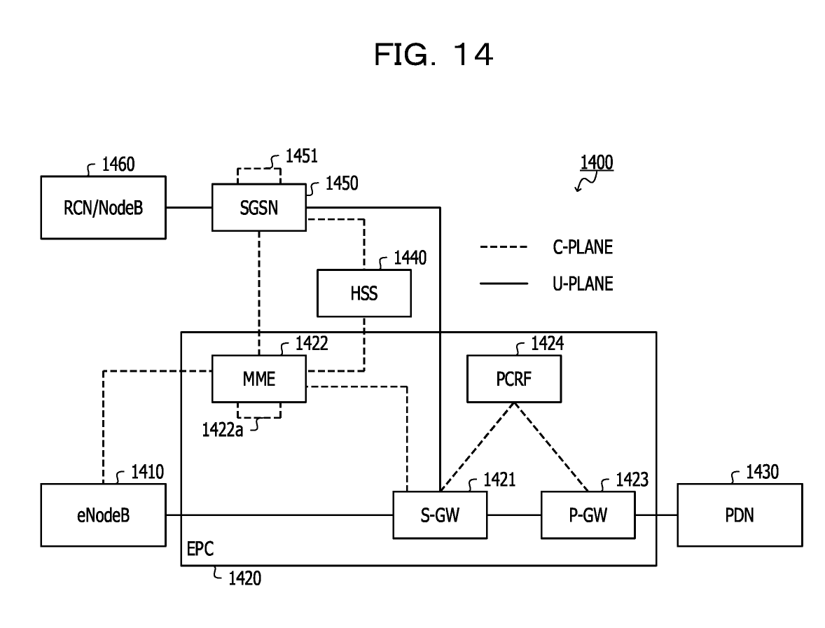

For example, at step S701 illustrated in FIG. 7, the small base station 120 may identify the QoS class of a service based on the QCI notified from the EPC. The following describes an EPC network including the EPC with reference to FIG. 14.

(EPC Network Applicable to Communication System According to Embodiment)

FIG. 14 illustrates an exemplary EPC network applicable to a communication system according to the embodiment. For example, an EPC network 1400 illustrated in FIG. 14 is applicable to the communication system 100 according to the embodiment. The EPC network 1400 is an exemplary EPC network specified by the 3GPP, and includes an eNB 1410, an EPC 1420, a packet data network (PDN) 1430, a home subscriber server (HSS) 1440, a serving GPRS support node (SGSN) 1450, and a radio control network (RCN)/NodeB 1460. The QoS described above is controlled by the EPC 1420. The EPC 1420 includes a S-GW 1421, a MMEs 1422 and a P-GW1423, and a Policy And Charging Rules Function (PCRF) 1424.

The eNB 1410 (eNodeB) is connected with the MME 1422 through a C-plane. The eNB 1410 is also connected with the S-GW 1421 through a U-plane. The base stations described above (for example, the macro base station 110, and the small base stations 120 and 130) are applicable to, for example, the eNB 1410.

The S-GW 1421 is connected with the MME 1422 and the PCRF 1424 through a C-plane. The S-GW 1421 is also connected with the eNB 1410, the P-GW1423, and the SGSN 1450 through a U-plane. The S-GWs 801 and 1101 described above is applicable to, for example, the S-GW 1421.

The MME 1422 is connected with the eNB 1410, the S-GWs 1421, the HSS 1440, and the SGSN 1450 through a C-plane. The MMEs 802 and 1102 described above are applicable to, for example, the MME 1422. An inter-MME interface 1422a is used for information communication between MMEs.

The P-GW1423 is connected with the S-GW 1421 and the PDN 1430 through a U-plane. The P-GW1423 is also connected with the PCRF 1424 through a C-plane. The P-GW 803 described above is applicable to, for example, the P-GW1423.

The PCRF 1424 is a processor that determines a QoS and a charging system applied to a user data packet transmitted and received by a user. The PCRF 1424 is connected with the S-GW 1421 and the P-GW1423 through a C-plane. The PDN 1430 is a network outside the EPC 1420.

The HSS 1440 is a processor that manages a service control and subscriber data. The HSS 1440 is connected with the MME 1422 and the SGSN 1450 through a C-plane.

The SGSN 1450 is a processor that performs packet exchange through a 3G network. The SGSN 1450 is connected with the MME 1422 and the HSS 1440 through a C-plane. The SGSN 1450 is also connected with the S-GW 1421 and the RCN/NodeB 1460 through a U-plane. An inter-SGSN interface 1451 is used for information communication between SGSNs.

The RCN/NodeB 1460 is a RCN and a base station (NodeB) in a 3G network. The RCN/NodeB 1460 is connected with the SGSN 1450 through a U-plane.

When a higher wired network is connected with the Internet (public network) like the EPC network 1400 illustrated in FIG. 14, a QoS policy is determined for each session (transfer). This determination of the QoS policy is performed based on the IP as the protocol of the Internet, and a band (different from a band in wireless communication) requested between mobile communication networks.

Then, a cooperation with IP-connectivity access network (IP-CAN) is performed based on a result of the determination of the QoS policy. This cooperation is called, for example, policy and charging control (PCC). The PCC performs a control of the QoS applied at each transfer of service data. The service data is called, for example, service data flow in LTE. This flow indicates data flow.

(TCP Option Applicable to Embodiment)

FIG. 15 illustrates an exemplary TCP option applicable to the embodiment. A TCP option 1500 illustrated in FIG. 15 is, for example, a TCP option included in a packet transmit and received between the macro base station 110 and the small base station 120. The TCP option 1500 includes an option number 1501, an option byte count 1502, a TS value 1503, and a TS echo response value 1504.

When “Ox08” is set to the option number 1501, the TCP option 1500 indicates a time stamp. In this case, the TS value 1503 stores time stamp information indicating the transmission time of data at the transmission source of the data. The TS echo response value 1504 stores time stamp information indicating the reception time of the data at the transmission destination of the data.

At step S703 illustrated in FIG. 7, the small base station 120 calculates a difference between the transmission time indicated by the TS value 1503 of a packet received from the macro base station 110 and the reception time of the packet at the small base station 120, for example. Accordingly, a transfer delay between the macro base station 110 and the small base station 120 may be measured.

(Random Access Procedure Applicable to Embodiment)

FIG. 16 is a sequence diagram illustrating an exemplary random access procedure applicable to the embodiment. At step S707 illustrated in FIG. 7, the terminal 101 and the small base station 120 execute, for example, the steps illustrated in FIG. 7 as the random access procedure.

First, the terminal 101 transmits a random access channel (RACH) preamble as message 1 to the small base station 120 (step S1601). For example, the terminal 101 randomly selects the RACH preamble and transmits the selected RACH preamble through a physical random access channel (PRACH). When a RACH response to the transmitted RACH preamble is not received, the terminal 101 retransmits the RACH preamble at lower transmission electric power.

Subsequently, the small base station 120 transmits a RACH response as message 2 for the RACH preamble received through step S1601, to the terminal 101 (step S1602). The RACH response includes information such as transmission timing information.

Subsequently, the terminal 101 transmits a RRC connection request as message 3 (step S1603). The RRC connection request is a higher-layer signal including an ID unique to the terminal 101. A wireless resource used in the transmission of the RRC connection request at step S1603 is selected based on, for example, the transmission timing information included in the RACH response received through step S1602.

Subsequently, the small base station 120 transmits RRC connection setup as message 4 (step S1604). The RRC connection setup is control information including cell setting information for RRC connection. The random access procedure illustrated in FIG. 16 is contention resolution, and thus the RRC connection setup includes, for example, the ID unique to the terminal 101 included in the RRC connection request transmitted through step S1603.

Accordingly, upon reception of the RRC connection request including the ID unique to the terminal 101, the terminal 101 may determine that connection with the small base station 120 is successful. Subsequently, a shared channel is established between the terminal 101 and the small base station 120 (step S1605), and then this random access procedure ends.

At step S1604, having not received the RRC connection request including the ID unique to the terminal 101, the terminal 101 may determine that connection with the small base station 120 is not successful. In this case, the terminal 101 returns to step S1601 to transmit the RACH preamble again.

Through the above-described steps, the terminal 101 may establish connection with the small base station 120. Thereafter, the terminal 101 switches a cell with which an uplink is performed to be the small base station 120. Accordingly, the small base station 120 is set as the P cell of the terminal 101.

(X2 Handover Applicable to Embodiment)

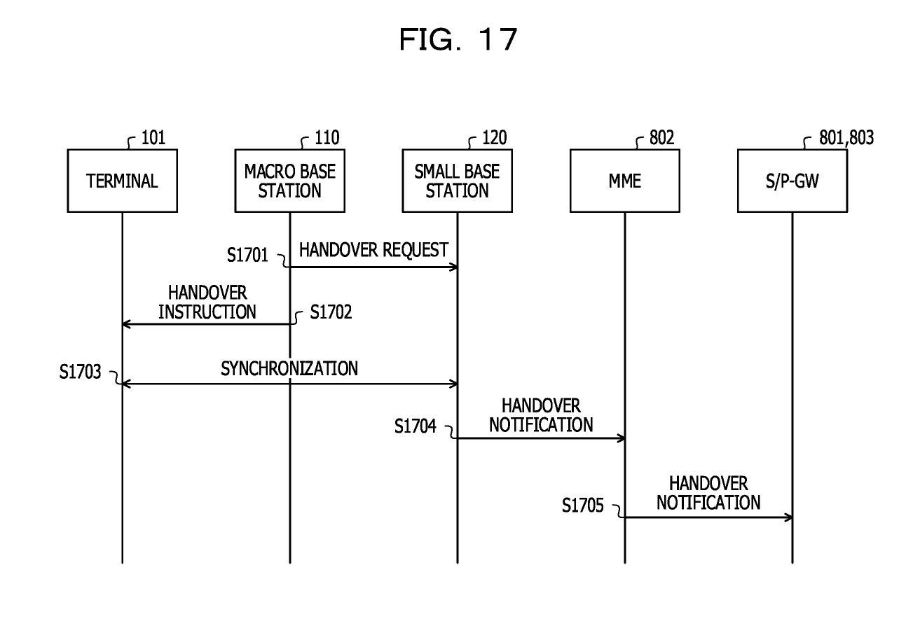

FIG. 17 is a sequence diagram illustrating an exemplary X2 handover applicable to the embodiment. At step S708 illustrated in FIG. 7, for example, when a base station to which the terminal 101 is handed over is a base station (for example, the small base station 120) connected with the MME 802 like the macro base station 110, the X2 handover illustrated in FIG. 17 is performed.

First, the macro base station 110 transmits, to the small base station 120, a handover request for a handover of the terminal 101 to the small base station 120 (step S1701). The macro base station 110 also transmits to the terminal 101 a handover instruction instructing the handover to the small base station 120 (step S1702).

Subsequently, a synchronization is performed for the terminal 101 and the small base station 120 to synchronize with each other (step S1703). Subsequently, the small base station 120 transmits, to the MME 802, a handover notification indicating that the terminal 101 is handed over to the small base station 120 (step S1704).

Subsequently, the MME 802 transmits, to the S-GW 801 and the P-GW 803, a handover notification indicating that the terminal 101 is handed over to the small base station 120 (step S1705), and ends the X2 handover. Through the above-described steps, the small base station 120 is set as the P cell of the terminal 101.

As illustrated in FIG. 17, in the X2 handover, the macro base station 110 and the small base station 120 directly transmits and receives information on the terminal 101. This may reduce a load on the core network. The X2 handover may be performed in a short time as compared to, for example, an S1 handover.

(S1 Handover Applicable to Embodiment)

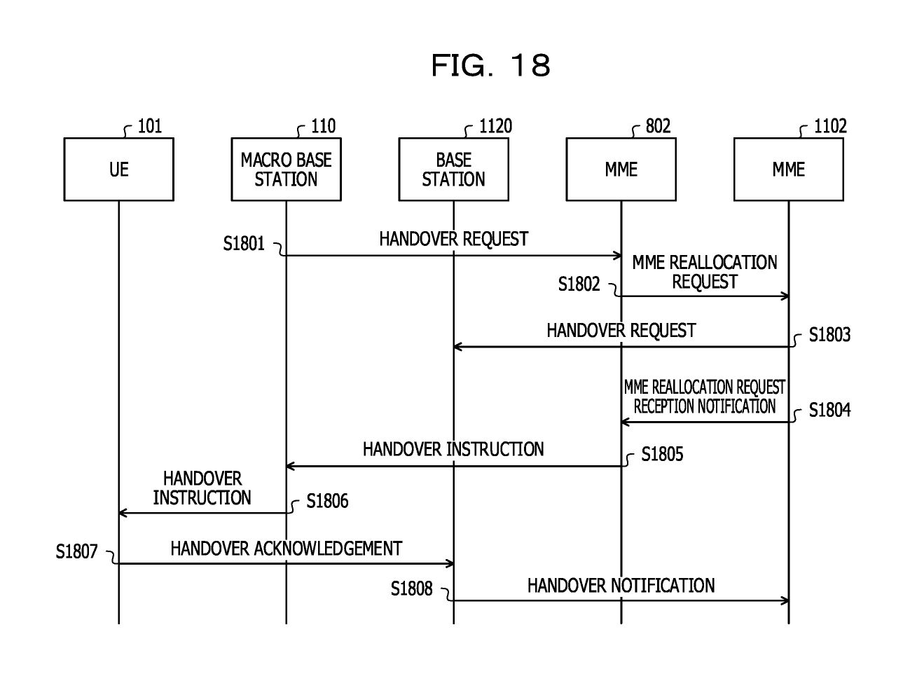

FIG. 18 is a sequence diagram illustrating an exemplary S1 handover applicable to the embodiment. At step S708 illustrated in FIG. 7, for example, when the X2 handover is not available or when the base station to which the terminal 101 is handed over is a base station (for example, the base stations 1110 and 1120) connected with a MME different from that of the macro base station 110, the S1 handover illustrated in FIG. 18 is performed.

The example illustrated in FIG. 18 describes a case in which the base station (target base station) to which the terminal 101 is handed over is the base station 1120 as illustrated in FIG. 11. In this case, the MME 802 is a source MME, and the MME 1102 is a target MME.

First, the macro base station 110 transmits, to the MME 802, a handover request for a handover of the terminal 101 to the base station 1120 (step S1801). Subsequently, the MME 802 transmits, to the MME 1102, a MME reallocation request for a MME reallocation that switches, from the MME 802 to the MME 1102, a MME that manages a bearer of the terminal 101 (step S1802).

Subsequently, the MME 1102 transmits, to the base station 1120, a handover request for the handover of the terminal 101 to the base station 1120 (step S1803). The MME 1102 also transmits, to the MME 802, a MME reallocation request reception notification indicating that the MME 1102 has received the MME reallocation request (step S1804).

Subsequently, the MME 802 transmits, to the macro base station 110, a handover instruction for the handover of the terminal 101 to the base station 1120 (step S1805). Subsequently, the macro base station 110 transmits, to the terminal 101, a handover instruction for the handover to the base station 1120 (step S1806).

Subsequently, the terminal 101 transmits, to the base station 1120, a handover acknowledgement indicating execution of the handover to the base station 1120 (step S1807). Subsequently, the base station 1120 transmits, to the MME 1102, a handover notification indicating that the terminal 101 executes the handover to the base station 1120 (step S1808), and then the S1 handover ends. Through the above-described steps, the small base station 120 is set as the P cell of the terminal 101.

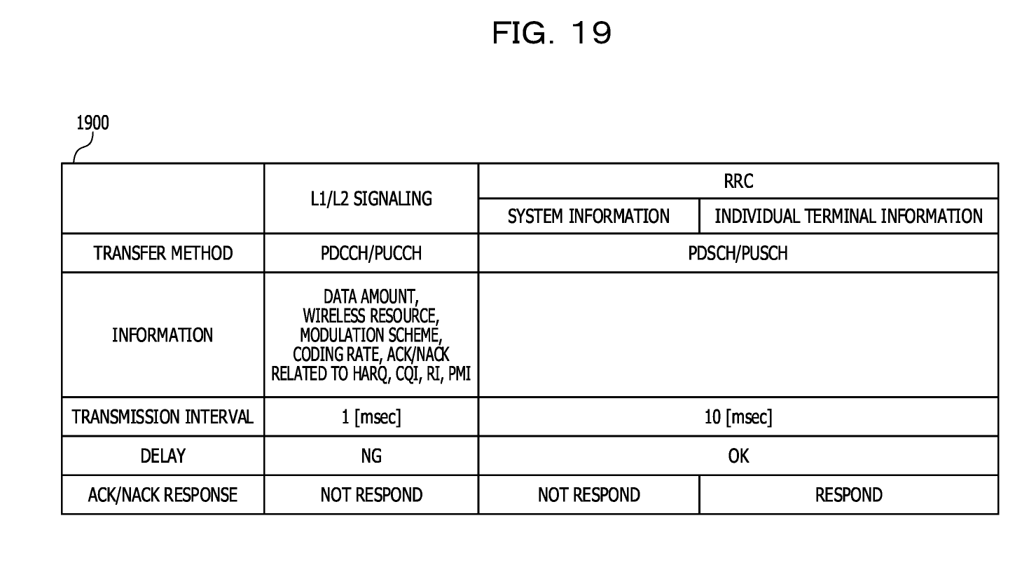

FIG. 19 illustrates an exemplary control signal in the embodiment. A table 1900 illustrated in FIG. 19 lists part of control information transmitted and received in the communication system 100 according to the embodiment. As listed in the table 1900, in the communication system 100, for example, L1/L2 signaling and RRC are transmitted and received. The RRC includes system information and individual terminal information.

The L1/L2 signaling is control information for a wireless signal. Since data (user data and RRC control information) transferred as the wireless signal is differently controlled for each subframe (1 [msec]), a dedicated control wireless channel is allocated for the data. For example, the L1/L2 signaling is transferred through PDCCH or Physical Uplink Control Channel (PUCCH).

The L1/L2 signaling includes the amount of data to be transferred which is selected through scheduling, a wireless resource, a modulation scheme, a coding rate, ACK or NACK related to HARQ, a channel quality indicator (CQI) indicating the wireless channel quality, a rank indicator (RI) indicating the number of streams, and a precoding matrix indicator (PMI) indicating a multiple-input multiple-output (MIMO) precoding matrix.

No response signal (ACK or NACK) for the L1/L2 signaling is returned from a receiving side. Thus, no response signal for the L1/L2 signaling is forwarded between base stations, and accordingly no communication delay due to a cell switching as described above occurs.

In contrast, a response signal for the individual terminal information included in the RRC is returned from a receiving side. Control information as the RRC is transmitted at an interval of the order of 10 [msec], and thus the transmission interval is long and control is slow as compared to the above-described PDCCH and PUCCH, PDCCH and PUCCH. In other words, the control information as the RRC is allowed a large transfer delay as compared to user data. Thus, communication performance is less affected even when the cell switching as described above is performed and a response signal for an individual terminal included in the RRC is forwarded between base stations.

As described above, according to the embodiment, it is possible to switch a transfer route of a response signal from the terminal 101 to the small base station 120 for transferred data from the small base station 120, depending on a transfer delay between the macro base station 110 and the small base station 120. This may suppress a communication delay due to the transfer delay of a response signal between the macro base station 110 and the small base station 120, thereby achieving a reduced communication delay.

According to the embodiment, it is possible to switch the transfer route of the response signal from the terminal 101 to the small base station 120 for the transferred data, depending on the communication type of transferred data from the small base station 120 to the macro base station 110. This allows, for example, the transfer route to be switched for data requested to be real time, thereby achieving a reduced communication delay of the data requested to be real time.

As described above, a communication system, a base stations device and a terminal device may achieve a reduced communication delay.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station being one of two base stations, the base station comprising:
a memory and;
a processor coupled to the memory and configured to select a state of a terminal from a first state and a second state based on at least one of a communication type of data transmitted from one of the two base stations to the terminal and a transfer delay between the two base stations, the first state being a state in which a base station of the two base stations that transmits the data to the terminal is different from a base station of the two base stations that receives from the terminal a response signal corresponding to the data, the second state being a state in which a base station of the two base stations that transmits the data to the terminal is same as a base station of the two base stations that receives from the terminal the response signal corresponding to the data.

2. The base station according to claim 1, wherein a retransmission control of the data is performed based on the response signal.

3. The base station according to claim 1, wherein
the state of the terminal is switched from the first state to the second state when the transfer delay between the two base stations is larger than a first predetermined value, and
the state of the terminal is not switched from the first state to the second state when the transfer delay between the two base stations is not larger than the first predetermined value.

4. The base station according to claim 1, wherein
the state of the terminal is switched from the first state to the second state when the communication type of the data transmitted to the terminal indicates to be real-time service, and
the state of the terminal is not switched from the first state to the second state when the communication type of the data transmitted to the terminal does not indicate to be real-time service.

5. The base station according to claim 1, wherein
the state of the terminal is switched from the first state to the second state when the transfer delay between the two base stations is larger than a first predetermined value or when the communication type of the data transmitted to the terminal indicates to be real-time service, and
the state of the terminal is not switched from the first state to the second state when the transfer delay between the two base stations is not larger than the first predetermined value and when the communication type of the data transmitted to the terminal does not indicate to be real-time service.

6. The base station according to claim 1, wherein
when the state of the terminal is the first state, the response signal transmitted from the terminal is forwarded between the two base stations.

7. The base station according to claim 1, wherein
one of the two base stations is configured to form a primary cell of a carrier aggregation, and
the other of the two base stations is configured to form a secondary cell of the carrier aggregation.

8. The base station according to claim 1, wherein
one of the two base stations is configured to form a macro cell, and
the other of the two base stations is configured to form a small cell that is smaller than the macro cell.

9. The base station according to claim 1, wherein
when the state of the terminal is switched from the first state to the second state and when a wireless quality between one of the two base stations and the terminal is higher than a second predetermined value and, the terminal is configured to perform handover to the one of the two base stations, and
when the state of the terminal is switched from the first state to the second state and when the wireless quality is higher than the second predetermined value, the terminal is configured to perform random access procedure to the one of the two base stations.

10. The base station according to claim 1, wherein
the terminal is configured to perform wireless communications with the two base stations simultaneously, a frequency band used for a wireless communication between one of the two base stations and the terminal being different from a frequency band used for a wireless communication between the other of the two base stations and the terminal.

11. A communication method comprising:
selecting, by one of two base stations, a state of a terminal from a first state and a second state based on at least one of a communication type of data transmitted from one of the two base stations to the terminal and a transfer delay between the two base stations, the first state being a state in which a base station of the two base stations that transmits the data to the terminal is different from a base station of the two base stations that receives from the terminal a response signal corresponding to the data, the second state being a state in which a base station of the two base stations that transmits the data to the terminal is same as a base station of the two base stations that receives from the terminal the response signal corresponding to the data.

12. A wireless communication system comprising:
two base stations; and
a terminal,
wherein one of the two base stations is configured to select a state of a terminal from a first state and a second state based on at least one of a communication type of data transmitted from one of the two base stations to the terminal and a transfer delay between the two base stations, the first state being a state in which a base station of the two base stations that transmits the data to the terminal is different from a base station of the two base stations that receives from the terminal a response signal corresponding to the data, the second state being a state in which a base station of the two base stations that transmits the data to the terminal is same as a base station of the two base stations that receives from the terminal the response signal corresponding to the data.
